(19) United States
(12) Patent Application Publication
(10) Pub. No.: US 2011/0163179 A1
(43) Pub. Date: Jul. 7, 2011

(54) DRINKING STRAW WITH OPAQUE, IMPRINTED SIDE

(76) Inventor: Erik Lipson, Philadelphia, PA (US)

(21) Appl. No.: 12/652,802

(22) Filed: Jan. 6, 2010

(51) Int. Cl. A47G 21/18; B29C 47/04

(52) U.S. Cl. 239/33; 264/75

(57) ABSTRACT

A tubular plastic drinking straw having a flat side with a message imprinted on the flat side is formed by an extruding head connected to two extruders, one of which contains an opaque plastic and the other of which extrudes a substantially transparent plastic. The plastics are fed simultaneously through an extruding die which generates a tubular shape with at least one flat side, with the opaque plastic forming a flat side. The flat side is then imprinted with a message formed of characters extending longitudinally along the length of the tube. The tube may then be bent into a sinuous shape for novelty purposes.

### FIELD OF THE INVENTION

This invention relates to novelty plastic drinking straws formed of two or more colors, with one of the colors being opaque, the straws having a flat side running the length of the straw, and to the method of making the straws.

### BACKGROUND OF THE INVENTION

Drinking straws formed of transparent plastic, and often curved into sinuous forms, are a popular novelty for use by children. The transparent walls of the straws allow children to watch liquid rising through the straw as the child sucks on the straw. These straws are usually circular in cross section and it is difficult to imprint a message, such as the trademark of the straw, the manufacturer of the straw, or a decorative design, along the length of the straw. Such message would be more easily printed and more visible if printed on a flat surface of the straw. At the same time, it is important to allow the straw, or at least the cross section of the straw which is not imprinted, to be largely transparent to allow viewing of the liquid rising through the straw.

### SUMMARY OF THE INVENTION

This present invention is accordingly directed toward a novelty plastic drinking straw, partially transparent in cross section and partially opaque, to allow a message of the type noted above to be imprinted lengthwise along the straw on the opaque section, and more particularly to such a straw in which the opaque section is formed on a flat side running the length of the straw. The present invention is also directed toward a method of making such a straw.

A preferred embodiment of the invention, which is subsequently disclosed in detail, is formed by an extrusion apparatus having an extruding head connected to two extruders, one of which provides a generally opaque plastic and the other which extrudes substantially transparent plastic. The plastics are fed simultaneously through an extruding die which generates a tubular shape with one at least one flat side. The flat side is then imprinted with a message formed of elements such as characters extending longitudinally along the length of the tube. The straw may be bent into a desired two-dimensional or three-dimensional shape while it is still at an elevated temperature or may be cut into desired lengths which may later be reheated and bent.

### BRIEF DESCRIPTION OF THE DRAWINGS

Other objectives, advantages, and applications of the present invention will be disclosed in the following description of preferred embodiments of the invention. The description makes reference to the accompanying drawings, in which:

FIG. 1 is a side view of a preferred embodiment of the imprinted drinking straw;

FIG. 2 is a cross-sectional view of the straw of FIG. 1, taken along line 2-2 of FIG. 1;

FIG. 3 is a cross-sectional view of an alternative embodiment of the straw;

FIG. 4 is a schematic diagram of a method of forming the straw of the present invention; and

FIG. 5 is a schematic diagram illustrating a method of bending the straws of the present invention.

### DETAILED DESCRIPTION OF THE PREFERRED EMBODIMENTS

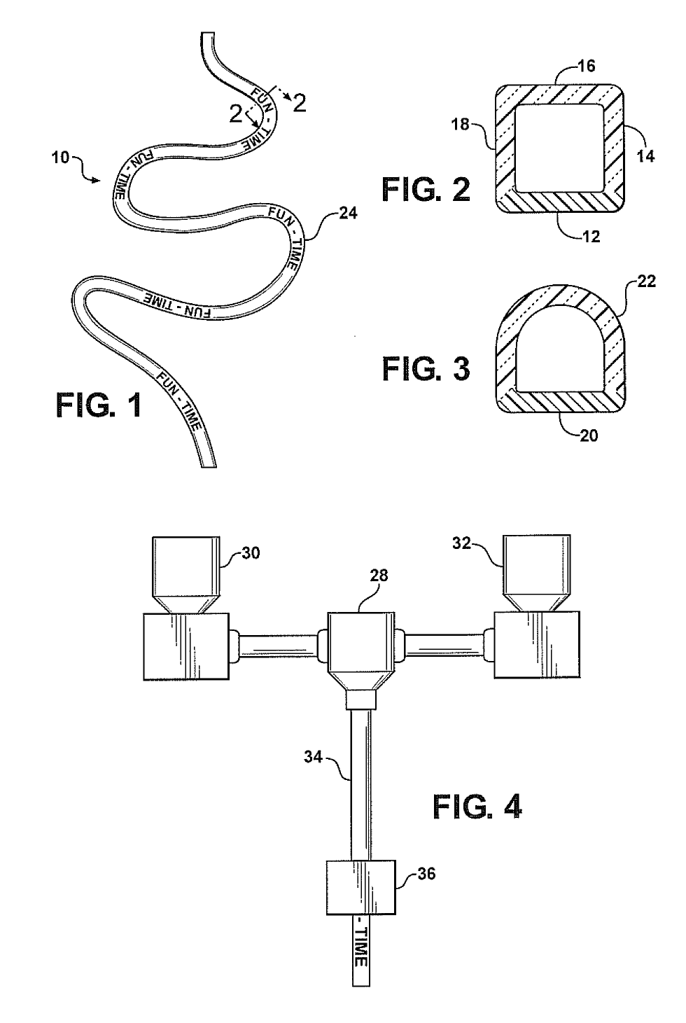

Referring to the drawings, a drinking straw formed in accordance with the present invention, generally indicated at 10 in FIG. 1, constitutes a plastic drinking straw having a cross section with at least one flat side. FIG. 2 is a cross section through the straw 10 taken along line 2-2 of FIG. 1. As shown in FIG. 2, the cross section of the tube is a rectangle, approximately square. One of the sides of the cross section, 12, is formed of a generally opaque plastic while the other three sides, 14, 16 and 18, are formed of a transparent plastic.

In an alternate configuration, illustrated in the cross section of FIG. 3, the tubing may have one flat opaque side 20 and a semicircular side 22, formed of a transparent plastic, with its ends joined to the ends of the flat section 20. The cross section could be formed in other configurations, as long as one of the sides is flat and generally opaque and the balance of the straw is largely transparent.

The presence of a flat, substantially opaque plastic side allows printing along the flat side, in the manner of 24 in FIG. 1. The imprinting may take the form of words, in the case of FIG. 1 the name of a manufacturer, repeatedly printed along the length of the straw 10, on the flat, generally opaque side, as illustrated at 24, or images such as cartoons, animal characters, or the like.

The significance of a flat side formed of substantially opaque plastic allows the imprinted words or graphics to be sharply visible against the background and to be clearly printed on the straw. The plastic of the flat imprinted side need not be totally opaque in order to provide high visibility to the printing formed on that side, thus the term “substantially opaque”. Similarly, the other sides need not be completely transparent but could be slightly translucent. The purpose of the transparent surfaces is to allow a child drinking through the straw to see the progress of the liquid through the straw, which is entertaining to children.

The imprinting 24 can be relatively short and repeated, as in the case of drinking straw 10, or it could be continuous along the flat side of the straw in alternative embodiments.

FIG. 4 schematically illustrates the extruding apparatus used to faun the straw with at least one flat side that is substantially opaque and other sides which are substantially transparent and the manner of imprinting upon the straw. In FIG. 4, 28 is an extruding head which contains an extruding die. The extruding head is serviced by two extruders 30 and 32. One of the extruders, 30, feeds substantially opaque plastic to the extruding head 28 while the extruder 32 feeds substantially transparent plastic. The extruding die within the extruding head 28 (not shown) uses the opaque plastic from extruder 30 to form one flat side, while the balance of the cross section of the straw is formed by the substantially transparent plastic from extruder 32.

The combined extrusion, in the form of tubing 34, is then passed under a printing head 36 which imprints the required letters or graphics on the flat side formed by substantially opaque plastic of the straw material 34. Afterward the straw material 34 may be passed through a chilling chamber and possibly subjected to a blower to dry ink formed on the tubing by the printing head 36.

The imprinted tubing may then be passed into a bending machine to produce the form illustrated in FIG. 1, or any other desired form. The tubing 34 exiting the printing head may be cut into straight lengths which are then reheated at a later time to a temperature above the glass transition temperature of the plastic used to allow subsequent bending or the tubing 34, having passing through the printing head 36, may be directly bent. The printing on the tubing may be done after it is bent into a desired two or three-dimensional shape.

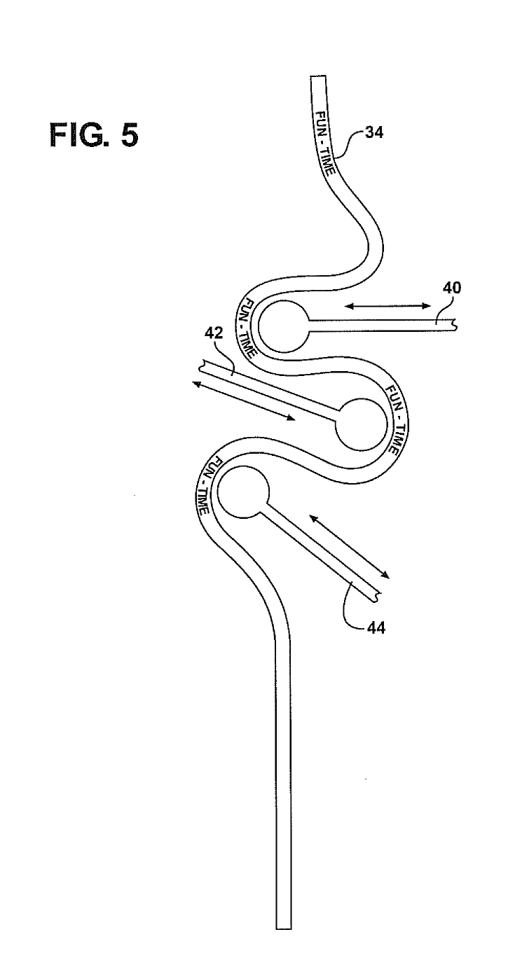

FIG. 5 illustrates a bending arrangement for configuring the soft plastic of the tubing 34 into the finished shape illustrated in FIG. 1. The tubing 34, at a temperature somewhere above its glass transition temperature, is subjected to lateral forces from three bending arms 40, 42 and 44, which impact the previously straight length of tubing at the angles indicated at FIG. 5 to produce the sinuous bends illustrated in FIG. 1.

As has been noted, the bending operation could be performed in line while the section 34 is still above its glass transition temperature. The heads 42 and 44 could be disposed at an angle to the paper so as to produce three-dimensional shapes. It is critical that the shapes not have sharp bends which would inhibit free flow of liquid through the straw, but otherwise almost any shape imaginable could be employed. They could be in the form of script signatures, animal designs, or the like.

Having thus disclosed my invention, I claim:

1. An elongated plastic tubular drinking straw having at least one flat side, with the flat side being printed with a message formed of characters arrayed along the length of the tube.

2. The drinking straw of claim 1 wherein the straw is polygonal in cross section.

3. The drinking straw of claim 2 in which the imprinted side of the polygon is opaque and the balance of the sides of the polygon are transparent.

4. The drinking straw of claim 1 having a cross section with one flat side and a semicircular side having its ends joined at the ends of the flat side.

5. The drinking straw of claim 1 which is extruded.

6. The drinking straw of claim 5 wherein the flat side is extruded in one color and the balance of the cross section of the tube is extruded in another color.

7. The drinking straw of claim 1 which is bent sinuously along its length.

8. The drinking straw of claim 7 wherein the drinking straw is bent so that the entire straw lies in a single plane.

9. The method of forming a drinking straw, comprising:
employing a multicolor extruder to extrude a tubular shape having at least one flat side in cross section formed of a first color while the balance of the cross section is formed of another color or is transparent and imprinting a message on said flat side with characters that are arrayed along the length of the straw.

10. The method of claim 9 wherein the multicolor extruder comprises a plurality of extruders feeding a single extruding head.
